(19) United States
(12) Patent Application Publication
(10) Pub. No.: US 2014/0211824 A1
(43) Pub. Date: Jul. 31, 2014

(54) LASER OSCILLATOR INCLUDING INCLINATION MEASURING UNIT FOR MEASURING INCLINATION AMOUNT OF INSIDE MIRROR

(71) Applicant: FANUC CORPORATION, YAMANASHI (JP)

(72) Inventors: TAKANORI SATO, YAMANASHI (JP); TAKAFUMI MURAKAMI, YAMANASHI (JP)

(73) Assignee: FANUC CORPORATION, YAMANASHI (JP)

(21) Appl. No.: 14/164,937

(22) Filed: Jan. 27, 2014

(30) Foreign Application Priority Data
Jan. 31, 2013 (JP) 2013-017574

(51) Int. Cl. H01S 3/086

(52) U.S. Cl. CPC H01S 3/086
USPC 372/107

(57) ABSTRACT

According to the present invention, a laser oscillator includes at least two mirrors and mirror holding units for holding the at least two mirrors such that the two mirrors can be inclined with respect to an optical axis. Each of the mirror holding units includes two inclination adjustment units configured to incline corresponding mirror, a pivot point portion configured to function as a pivot point when the mirror is inclined, and one inclination measuring unit configured to measure an inclination amount of the mirror inclined by the two inclination adjustment units. The inclination measuring unit is disposed in a region other than on straight lines connecting the pivot point portion with each of the inclination adjustment units.

### BACKGROUND OF THE INVENTION

1. Field of the Invention

The present invention relates to a laser oscillator including an inclination measuring unit for measuring an inclination amount of an inside mirror.

2. Description of Related Art

A laser oscillator is used for cutting and welding a workpiece, and the like. An output of the laser oscillator is reduced as an inside mirror included in a resonator is contaminated or deteriorated over time. Thus, the inside mirror needs to be periodically removed from the resonator for cleaning or replacement. After the inside mirror is mounted into the resonator again, it is necessary to adjust an inclination amount of the inside mirror in order to adjust an optical axis of the resonator.

The optical axis of the resonator in a conventional laser oscillator can be adjusted as follows: First, two of a plurality of inside mirrors in the resonator are selected. The inside mirrors are mounted to stages provided with two adjustment units for inclining the corresponding inside mirror relative to two directions orthogonal to each other.

A first mirror of the selected two mirrors is inclined by a certain amount relative to one of the two directions orthogonal to each other. The other mirror, i.e., a second mirror, is then inclined relative to the same direction to which the first mirror has been inclined, so as to adjust an inclination amount of the second mirror so as to maximize a laser output value. The inclination amount of the first. mirror and the maximum laser output value are recorded. By repeatedly performing the above-described process a plurality of times with varying inclination amounts of the first mirror, relationship between the inclination amount of the first mirror and the laser output value can be obtained.

FIG. 7 illustrates relationship R between an inclination amount X of the first mirror of the two mirrors selected, and a laser output value Y. As illustrated in FIG. 7, the laser output value Y takes a peak value Y0 at an inclination amount X0. A straight line L is drawn parallel with a horizontal axis at an output value Y1 which is smaller than the peak value Y0 by a predetermined ratio A. The predetermined ratio A is set within a range between 10% and 30% of the peak value Y0, for example. The inclination amounts where the straight line L crosses a graph of the relationship R are defined as X1 and X2, respectively. The first mirror is inclined by an inclination amount XM corresponding to a middle point between the inclination amounts X1 and X2. Subsequently, the inclination amount of the second mirror is adjusted to maximize the laser output value maximum. In this way, a view area through which a laser beam passes between the first mirror and second mirror subjected to the adjustment can be maximized.

With respect to the other direction of the two directions orthogonal to each other, the similar process is carried out. When more than two inside mirrors are used, an adjustable combination is selected from other inside mirrors and a similar process is carried out successively. In this way, the laser beam which allows for a large view area with low interference and decreased output loss can be obtained.

A micrometer may be used to adjust the inclination amount of such an inside mirror. In this case, a height of the stage holding the mirror is adjusted by the micrometer. The micrometer serves as an adjustment unit for inclining the mirror and as an inclination measuring unit for measuring the inclination amount.

A technique for adjusting the inclination amount of the mirror by combining an adjustment screw and a displacement sensor is also known (see JP-A-63-038354). JP-A-63-038354 discloses a laser oscillator which includes a cylindrical container, a mirror mounted to a ring member mounted to the container such that an inclination angle thereof can be adjusted, a mirror holding unit for holding the mirror, and an adjustment screw for displacing the mirror holding unit with respect to the ring member. The laser oscillator also includes a sensor for measuring a travel amount of the mirror holding unit.

According to a conventional adjustment method for adjusting the inclination amount of the mirror, there is one inclination measuring unit for one adjustment unit for inclining the mirror. Thus, in order to incline the mirror relative to two directions orthogonal to each other, two adjustment units and two inclination measuring units are required. As a result, the configuration of the resonator tends to be complicated, thereby increasing cost.

Therefore, there is a need for an inexpensive laser oscillator having a simple configuration.

### SUMMARY OF THE INVENTION

According to a first aspect of the present application, a laser oscillator including: at least two mirrors; and mirror holding units for holding the at least two mirrors such that the at least two mirrors can be inclined with respect to an optical axis, wherein each of the mirror holding units comprises two inclination adjustment units configured to incline the mirror, a pivot point portion configured to function as a pivot point when the mirror is inclined, and one inclination measuring unit configured to measure an inclination amount of the mirror which is inclined by the two inclination adjustment units, and wherein the inclination measuring unit is situated at a position, except for any position on straight lines connecting the pivot point portion and each of the inclination adjustment units, is provided.

According to a second aspect of the present application, in the laser oscillator according to the first aspect, the inclination measuring unit is configured to be detachably mounted to the mirror holding units.

According to a third aspect of the present application, in the laser oscillator according to the first or second aspect, the inclination measuring unit further comprises a displacement meter, a display unit configured to visually display a measurement value of the displacement meter, and an output unit configured to output the measurement value of the displacement meter to an outside.

These and other objects, features and advantages of the present invention will become more apparent in light of the detailed description of exemplary embodiments thereof as illustrated by the drawings.

### BRIEF DESCRIPTION OF THE DRAWINGS

FIG. 1 illustrates a configuration of a resonator of a laser oscillator according to one embodiment of the present invention;

FIG. 2 is a cross sectional view illustrating a mirror holding unit;

FIG. 3 illustrates a positional relationship between a pivot point portion, inclination adjustment units, and an inclination measuring unit of the mirror holding unit;

FIG. 4A illustrates a function of the inclination measuring unit of the mirror holding unit;

FIG. 4B. illustrates a function of the inclination measuring unit of the mirror holding unit;

FIG. 5 illustrates a positional relationship between a pivot point portion, inclination adjustment units, and an inclination measuring unit of a mirror holding unit in a laser oscillator according to a variant;

FIG. 6A illustrates a function of the inclination measuring unit of the mirror holding unit illustrated in FIG. 5;

FIG. 6B illustrates a function of the inclination measuring unit of the mirror holding unit illustrated in FIG. 5; and

FIG. 7 illustrates a relationship between an inclination amount of a first mirror and a laser output.

### DETAILED DESCRIPTION OF THE INVENTION

With reference to the accompanying drawings, embodiments of the present invention will be described. Constituent elements of the illustrated embodiments may be modified in size in relation to one another for better understanding of the present invention.

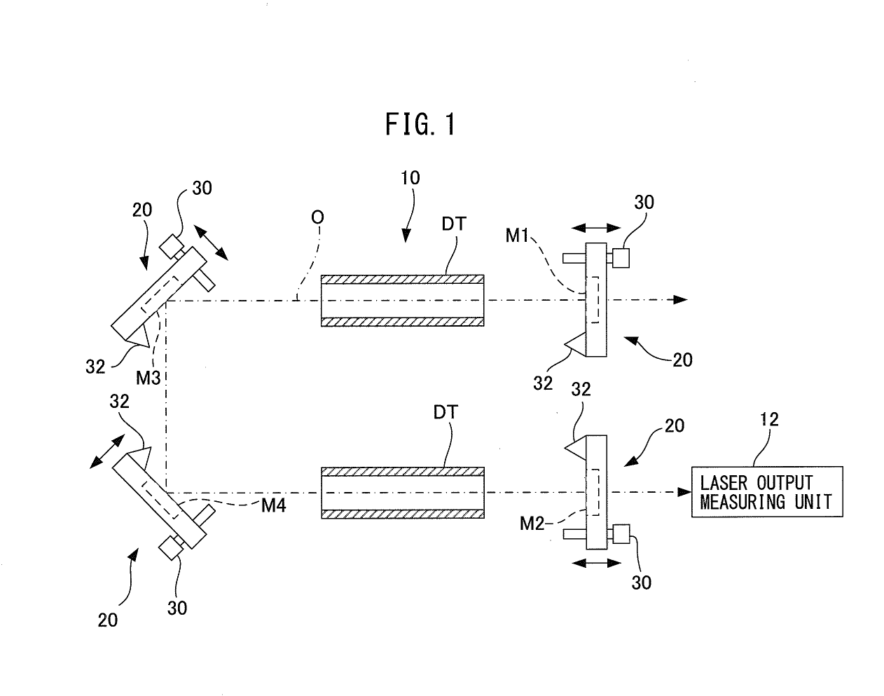

FIG. 1 illustrates an entire configuration of a resonator 10 of a laser oscillator according to one embodiment of the present invention. The resonator 10 includes an output mirror M1 of a partially transmissive mirror, a rear mirror M2 of a partially transmissive mirror, a first return mirror M3 of a totally reflective mirror, and a second return mirror M4 of a total reflection mirror. The mirrors M1, M2, M3, and M4 are each held by corresponding mirror holding units 20 provided with inclination adjustment units 30. The inclination adjustment units 30 of the mirror holding unit 20 have a function for inclining the mirrors M1, M2, M3, and M4 with respect to an optical axis O with a pivot point at a pivot point portion 32. Arrows illustrated in FIG. 1 indicate that the mirrors M1, M2, M3, and M4 can be inclined relative to each direction parallel with a drawing surface. However, as further described below, the mirrors M1, M2, M3, and M4 can be also inclined relative to a direction orthogonal to the direction illustrated in FIG. 1.

The exemplary laser oscillator is a discharge excitation type oscillator which includes discharge tubes DT provided in parallel with each other and between the output mirror M1 and the first return mirror M3 and between the rear mirror M2 and the second return mirror M4. The discharge tubes DT contain excitable media. The excitable media contained in the discharge tubes DT are excited by a discharging unit (not shown) disposed near the discharge tubes DT to emit a beam to the outside.

The beam discharged in this way is reflected by the mirrors M1, M2, M3, and M4 and amplified through resonation. The beam whose energy exceeds a certain level passes through the output mirror M1 and is output from the laser oscillator. The laser output from the laser oscillator is used to cut and weld a workpiece, for example. The beam passing through the rear mirror M2 is input to a laser output measuring unit 12 for measuring a laser output.

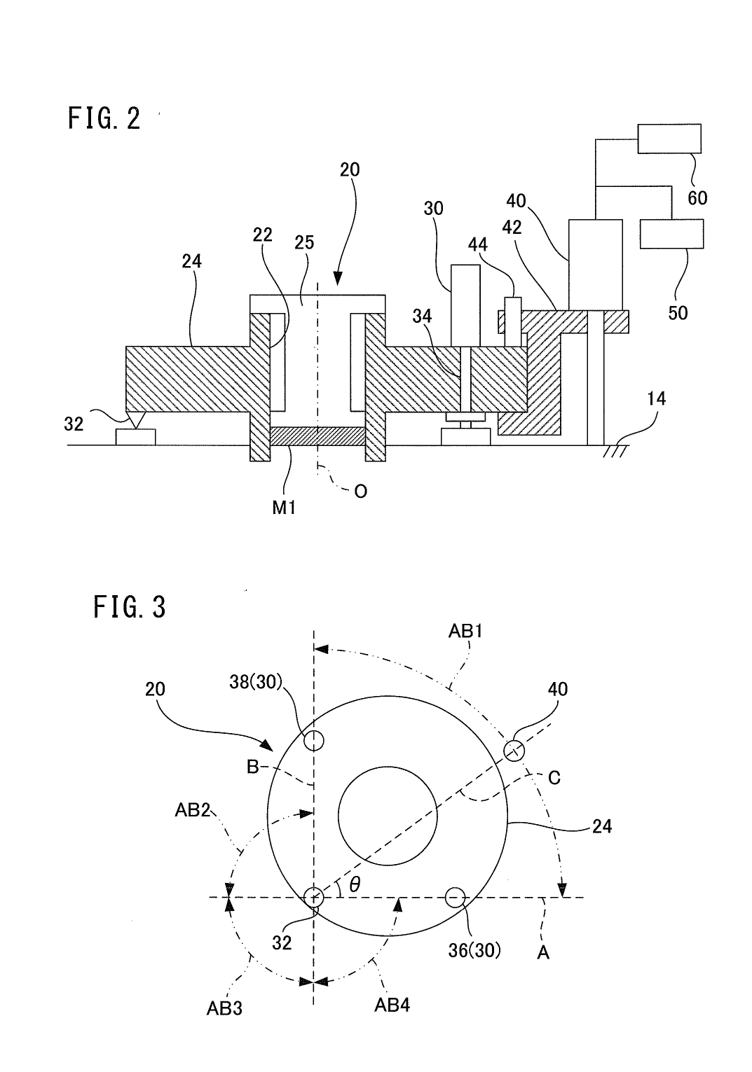

With reference to FIGS. 2 and 3, a configuration of the mirror holding unit 20 for the mirrors M1, M2, M3, and M4 will be described. For convenience, the mirror holding unit 20 for the output mirror M1 will be described below by way of example; however, mirror holding units 20 having a similar configuration can be used for the rear mirror M2, the first return mirror M3, and the second return mirror M4.

FIG. 2 is a cross sectional view illustrating the mirror holding unit 20. FIG. 3 illustrates a positional relationship between a pivot point portion 32, inclination adjustment units 30, and an inclination measuring unit 40 of the mirror holding unit 20. As illustrated in FIG. 2, the mirror holding unit 20 includes a stage 24 substantially in the form of a circular disk, which is formed with a through hole 22 for receiving the output mirror M1. The mirror holding unit 20 also includes a holder 25 inserted to the through hole 22 and adapted to hold the output mirror M1. The mirror holding unit 20 also includes two inclination adjustment units 30 for inclining the stage 24 and therefore the output mirror M1 with respect to the optical axis O and relative to two directions orthogonal to each other. The mirror holding unit 20 also includes a pivot point portion 32 which serves as a pivot point when the output mirror M1 is inclined. The mirror holding units 20 also includes an inclination measuring unit 40 for measuring an inclination amount of the output mirror M1. The mirror holding unit 20 also includes a display unit 50 for visually displaying a measurement result of the inclination measuring unit 40. The mirror holding unit 20 also includes an output unit 60 for outputting the measurement result of the inclination measuring unit 40 to the outside.

The mirror holding unit 20 is mounted to a supporting block 14 provided at a predetermined position in the resonator 10. Since the supporting block 14 and the stage 24 of the mirror holding unit 20 may have any shape, a detailed explanation will be omitted herein.

The inclination adjustment units 30 further includes a first inclination adjustment unit 36 and a second inclination adjustment unit 38 (see FIG. 3). For example, the first inclination adjustment unit 36 and the second inclination adjustment unit 38 are micrometers provided with an adjustment screw 34 (see FIG. 2). The first inclination adjustment unit 36 and the second inclination adjustment unit 38 can incline the stage 24 by rotating the adjustment screw 34 with the pivot point portion 32 serving as the pivot point. The first inclination adjustment unit 36 and the second inclination adjustment unit 38 can be operated independently of each other.

As illustrated in FIG. 3, a straight line A connecting the pivot point portion 32 and the first inclination adjustment unit 36 extends orthogonally to a straight line B connecting the pivot point portion 32 and the second inclination adjustment unit 38. With this arrangement, the stage 24 and therefore the output mirror M1 can be inclined with respect to the optical axis O and relative to the directions orthogonal to each other.

The inclination measuring unit 40 is fixed to the stage 24 of the mirror holding unit 20 by way of a mounting screw 44 via a bracket 42. With this arrangement, the inclination measuring unit 40 can be easily removed from the stage 24, after adjustment of the inclination amount of each of the mirrors M1, M2, M3, and M4 is completed. The inclination measuring unit 40 includes any known displacement meter such as a contact-type displacement meter. The inclination measuring unit 40 is connected to the display unit 50 for visually displaying the measurement value of the inclination amount of the output mirror Ml, for example in the form of digital information. The display unit 50 is disposed at an appropriate location where an operator can easily check the measurement value. In this way, with the display unit 50 provided separately from the inclination measuring unit 40, the operator can check the measurement result easily and safely. Further, since the output unit 60 for outputting the measurement value of the inclination amount of the output mirror M1 to a control device or the like is provided, the measured inclination amount can be output to the outside.

The inclination measuring unit 40 is situated at a position, except for any position on the straight lines A and B connecting the pivot point portion 32 and the inclination adjustment units 30. According to the example illustrated in FIG. 3, the inclination measuring unit 40 is situated on a straight line C extending at an angle θ with respect to the straight line A. Although not illustrated, the inclination measuring unit 40 can be disposed at any position within an area AB1 satisfying 0°<θ<90°, an area AB2 satisfying 90°<θ<180°, an area AB3 satisfying 180°<θ<270°, and an area AB4 satisfying 270°<θ<360°.

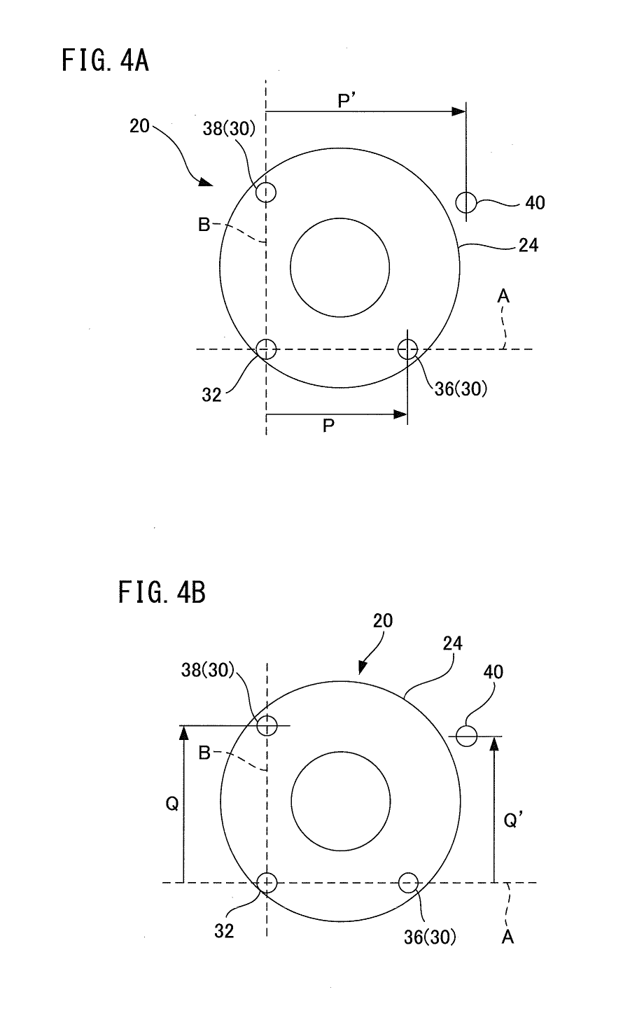

FIGS. 4A and 4B illustrate a function of the inclination measuring unit 40 of the mirror holding unit 20. FIG. 4A illustrates the case where the mirror holding unit 20 is inclined relative to a direction of the straight line A with the mirror holding unit 20 fixed relative to a direction of the straight line B. When the first inclination adjustment unit 36 is operated to incline the mirror holding unit 20 by a certain amount relative to the direction of the straight line A, the inclination measuring unit 40 is displaced correspondingly to inclination of the mirror holding unit 20. Based on a measurement value of a displacement amount of the inclination measuring unit 40, the inclination amount of the mirror holding unit 20 by the first inclination adjustment unit 36 is calculated. The inclination amount of the mirror holding unit 20 and therefore the inclination amount of each of the mirrors M1, M2, M3, and M4 can be calculated based on the measurement value of the inclination measuring unit 40 and on a ratio between a length P of a perpendicular line drawn from the first inclination adjustment unit 36 to the straight line B and a length P′ of a perpendicular line drawn from the inclination measuring unit 40 to the straight line B.

As opposed to FIG. 4A, FIG. 4B illustrates the case where the mirror holding unit 20 is inclined relative to the direction of the straight line B with the mirror holding unit 20 fixed relative to the direction of the straight line A. In this case, the second inclination adjustment unit 38 is operated to incline the mirror holding unit 20 relative to the direction of the straight line B. Similarly, the inclination amount of the mirror holding unit 20 and therefore the inclination amount of each of the mirrors M1, M2, M3, and M4 can be calculated based on the measurement value of the inclination measuring unit 40 and on a ratio between a length Q of a perpendicular line drawn from the second inclination adjustment unit 38 to the straight line A and a length Q′ of a perpendicular line drawn from the inclination measuring unit 40 to the straight line A.

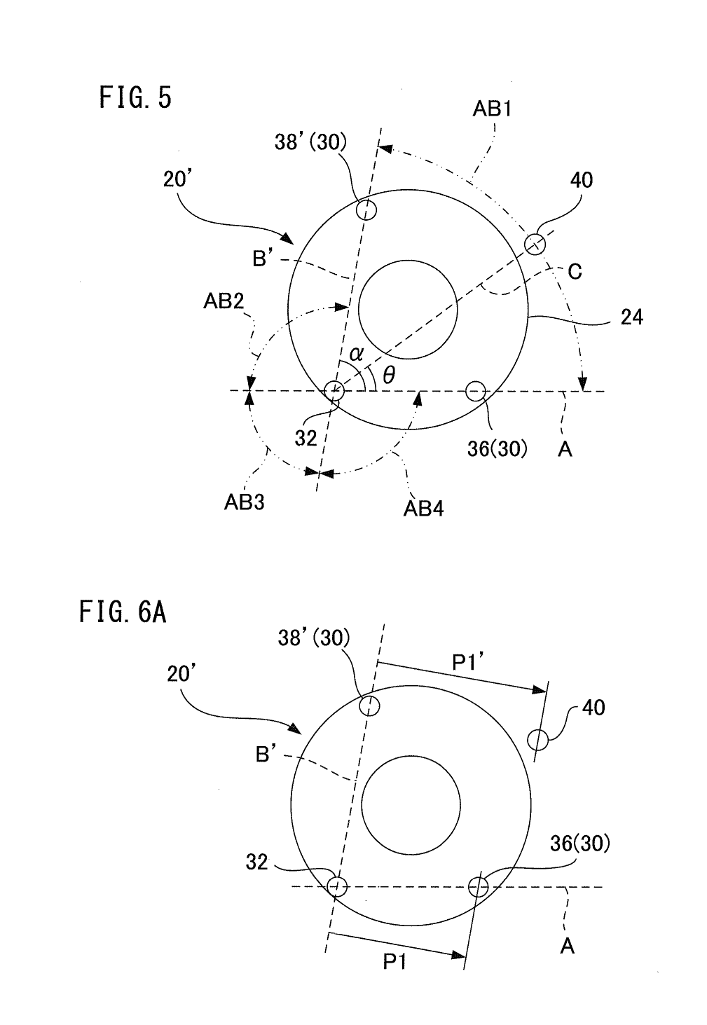

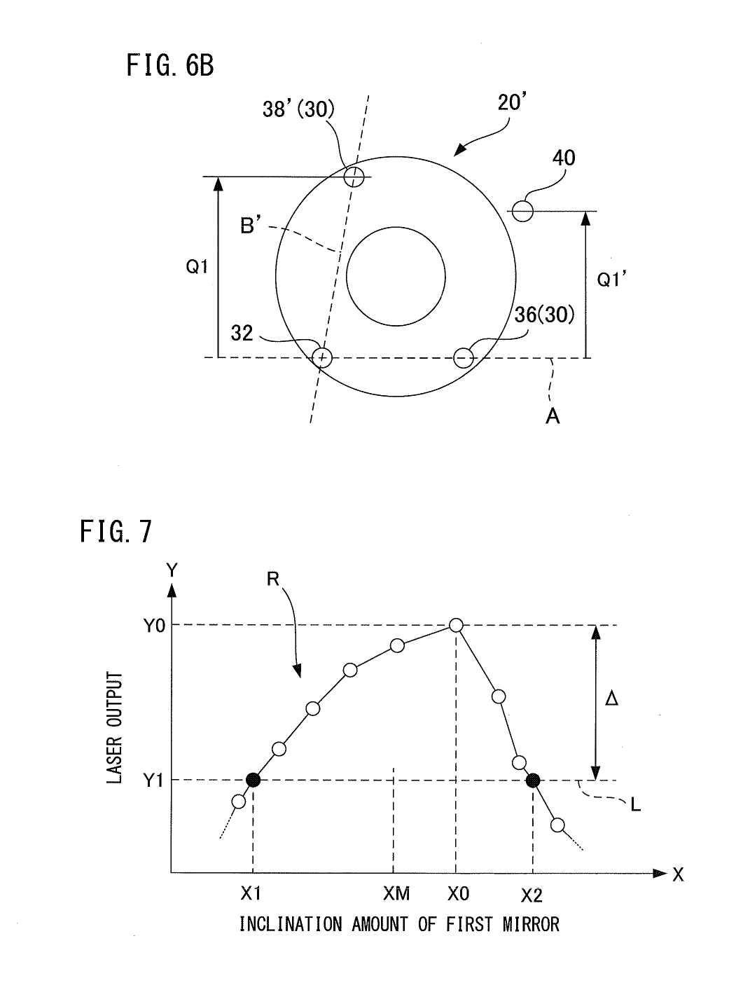

FIG. 5 illustrates a positional relationship between a pivot point portion 32, inclination adjustment units 30, and an inclination measuring unit 40 of a mirror holding unit 20′ in a laser oscillator according to a variant. FIG. 6A illustrates a function of the inclination measuring unit 40 of the mirror holding unit 20′ illustrated in FIG. 5. FIG. 6B illustrates a function of the inclination measuring unit 40 of the mirror holding unit 20′ illustrated in FIG. 5.

As illustrated in FIG. 5, according to this variant, a straight line A connecting the pivot point portion 32 and a first inclination adjustment unit 36 and a straight line B′ connecting the pivot point portion 32 and a second inclination adjustment unit 38′ respectively extend to define an angle a therebetween. With this arrangement, the stage 24 and therefore the output mirror M1 can be inclined relative to the respective directions of the straight lines A and B′ by the first inclination adjustment unit 36 and the second inclination adjustment unit 38′.

The inclination measuring unit 40 is disposed at a position, except for any position on the straight lines A and B′ connecting the pivot point portion 32 and the inclination adjustment units 30. According to the variant illustrated in FIG. 5, the inclination measuring unit 40 is disposed on a straight line C extending at an angle θ with respect to the straight line A. For example, as illustrated in FIG. 5, when 0°<α<90° is satisfied, the inclination measuring unit 40 can be disposed at any position within an area AB1 satisfying 0°<θ<α, an area AB2 satisfying α<θ<180°, an area AB3 satisfying 180°<θ<180+α, and an area AB4 satisfying 180+α<θ<360°.

In this way, even when the straight line A connecting the pivot point portion 32 and the first inclination adjustment unit 36 and the straight line B′ connecting the pivot point portion 32 and the second inclination adjustment unit 38 are not orthogonal to each other, the inclination amount of the mirror can also be calculated in a similar manner as described in relation to the above embodiment. More specifically, as illustrated in FIG. 6A, a ratio between a length P1 of a perpendicular line drawn from the first inclination adjustment unit 36 to the straight line B′ and a length P1′ of a perpendicular line drawn from the inclination measuring unit 40 to the straight line B′ can be calculated. Based on the ratio between the lengths and on the measurement value of the inclination measuring unit 40, the inclination amount of the mirror by the first inclination adjustment unit 36 can be obtained. Similarly, as illustrated in FIG. 6B, a ratio between a length Q1 of a perpendicular line drawn from the second inclination adjustment unit 38′ to the straight line A and a length Q1′ of a perpendicular line drawn from the inclination measuring unit 40 to the straight line A can be calculated. Based on the ratio between the lengths and on the measurement value of the inclination measuring unit 40, the inclination amount of the mirror by the second inclination adjustment unit 38′ can be obtained.

As described above, according to the present invention, one inclination measuring unit is provided for two inclination adjustment units for inclining the mirror of the resonator. This allows the laser oscillator to have a simple configuration, thereby reducing the cost. Further, since the inclination measuring unit can be detachably mounted to the mirror holding unit, special inclination measuring units for the respective mirror holding units are no longer required, thereby reducing the cost. Furthermore, since the display unit for displaying the measurement result by the inclination measuring unit is provided separately from the inclination measuring unit, the measurement result can be easily checked even when the laser oscillator is disposed at a place where the operator may have difficulty accessing the laser oscillator. This may enhance operational efficiency and also ensure operator safety.

### EFFECT OF THE INVENTION

According to the invention of the present application, by means of a single inclination measuring unit, the inclination amount of the mirror inclined by two inclination adjustment units can be measured. This allows the laser oscillator to have a simple configuration, thereby reducing the cost. Further, irrespective of whether or not the straight lines connecting the respective two inclination adjustment units and the pivot point portion are orthogonal, the inclination amount of the mirror can be measured. Therefore, the inclination adjustment unit may have more freedom with respect to a position where it can be disposed.

Although the embodiments of the present invention have been described above, it is obvious for a person skilled in the art that the function and effect intended by the present invention can be obtained by other embodiments as well. In particular, the constituent elements of the above-described embodiments can be omitted or replaced and known means may also be further provided, without departing from the spirit and scope of the present invention. Further, it is obvious for a person skilled in the art that the present invention may also be implemented by any combination of features of the embodiments explicitly or implicitly disclosed in the present specification.

What is claimed is:

1. A laser oscillator comprising:
at least two mirrors; and
mirror holding units for holding the at least two mirrors such that the at least two mirrors can be inclined with respect to an optical axis,
wherein each of the mirror holding units comprises two inclination adjustment units configured to incline the mirror, a pivot point portion configured to function as a pivot point when the mirror is inclined, and one inclination measuring unit configured to measure an inclination amount of the mirror which is inclined by the two inclination adjustment units, and
wherein the inclination measuring unit is situated at a position, except for any position on straight lines connecting the pivot point portion and each of the inclination adjustment units.

2. The laser oscillator according to claim 1, wherein the inclination measuring unit is configured to be detachably mounted to the mirror holding units.

3. The laser oscillator according to claim 1, wherein the inclination measuring unit further comprises a displacement meter, a display unit configured to visually display a measurement value of the displacement meter, and an output unit configured to output the measurement value of the displacement meter to an outside.
